(19) United States
(12) Patent Application Publication
(10) Pub. No.: US 2025/0184949 A1
(43) Pub. Date: Jun. 5, 2025

(54) User Equipment Location Delivery In Mobile Communications

(71) Applicant: MediaTek Singapore Pte. Ltd., Singapore (SG)

(72) Inventors: Marko Niemi, Oulu (FI); Guillaume Sebire, Oulu (FI)

(21) Appl. No.: 18/940,633

(22) Filed: Nov. 7, 2024

Related U.S. Application Data
(60) Provisional application No. 63/605,616, filed on Dec. 4, 2023.

(51) Int. Cl. H04W 64/00

(52) U.S. Cl. CPC H04W 64/00

(57) ABSTRACT

Solutions pertaining to improvements to user equipment (UE) location delivery in mobile communications are proposed. An apparatus implemented in a UE supporting of providing UE coarse location information via NAS signaling, establishing a non-access stratum (NAS) signaling connection with the network, starting/performing a procedure with the UE and providing the UE coarse location information to the network in an early phase of signaling in a secure manner.

### CROSS REFERENCE TO RELATED PATENT APPLICATION(S)

The present disclosure is part of a non-provisional application claiming the priority benefit of U.S. Provisional Patent Application No. 63/605,616, filed 4 Dec. 2023, the content of which being incorporated by reference in its entirety.

### TECHNICAL FIELD

The present disclosure is generally related to mobile communications and, more particularly, to improvements to user equipment (UE) location delivery in mobile communications.

### BACKGROUND

Unless otherwise indicated herein, approaches described in this section are not prior art to the claims listed below and are not admitted as prior art by inclusion in this section.

In wireless communications such as mobile communications according to the 3^{rd} Generation Partnership Project (3GPP) specifications, machine type communication (MTC) or more generally, Internet of Things (IoT), represents a significant growth opportunity for the 3GPP ecosystem. To support IoT, the 3GPP has specified narrowband IoT (NB-IoT) as a new cellular radio technology, which inherits generic functionalities from the Long-Term Evolution (LTE) with simplifications and optimizations to provide lower energy consumption, better coverage, and support of a massive number of low-throughput devices with relaxed delay requirements. Accordingly, a UE and a network may support a satellite Evolved-UMTS Terrestrial Radio Access network (E-UTRAN) access in wideband S1 (WB-S1) mode or narrowband S1 (NB-S1) mode (NB-IoT) with cellular IoT (CIoT) Evolved Packet System (EPS) optimization. Support for satellite E-UTRAN access is specified in 3GPP Technical Specification (TS) 36.300.

At a given time, in a UE geolocation, a non-terrestrial network (NTN) cell coverage may span over multiple regulatory areas (e.g., countries), some of which do not allow service(s) to be provided due to (regulatory) restrictions. The UE, while in the NTN cell coverage, may initiate an attach procedure, an initial registration procedure, or another registration type of procedure to request a service to which the network needs to respond. Without UE delivered information, the network may not be able to determine whether or not the UE is allowed to receive the requested service. If the UE is not allowed to operate at its current location due to restriction(s), the network should be able to reject the UE's request. However, an IoT device does not have a fast, simple and secure method to provide its location information to the network in an early phase of signaling. Therefore, there is a need for a solution for improvements to UE location delivery in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, designs, concepts, techniques, methods, systems and apparatus to address aforementioned issues. Specifically, various proposed schemes in accordance with the present disclosure pertain to improvements to UE location delivery in mobile communications. For instance, implementations of one or more schemes proposed herein may allow a UE to provide its location information in an early phase of signaling in a secure manner, such as in an attach procedure, registration procedure, tracking area update (TAU), security mode control or a corresponding 6^{th} Generation (6G) procedure while establishing a new non-access stratum (NAS) signaling connection. There may be multiple approaches for a network to request the UE to provide its location information and to encapsulate the UE location information into an uplink (UL) NAS message (e.g., an ATTACH REQUEST, ATTACH COMPLETE, TAU or SECURITY MODE COMPLETE message). It is noteworthy that, although examples described below may be in the context of 4^{th} Generation (4G) EPS signaling, the various schemes proposed herein may be adopted in NAS protocols in 5^{th} Generation (5G) or 6G and beyond for corresponding procedures.

In one aspect, a method may involve a UE performing a NAS procedure with a network. The method may also involve the UE providing, responsive to a request from the network, UE location information to the network while establishing the NAS procedure is ongoing.

In another aspect, a method may involve a UE performing an attach procedure with a network. The method may also involve the UE providing UE location information to the network while the attach procedure with the network is ongoing.

It is noteworthy that, although description provided herein may be in the context of certain radio access technologies, networks and network topologies such as 4G EPS mobile networking, the proposed concepts, schemes and any variation(s)/derivative(s) thereof may be implemented in, for and by other types of wireless and wired communication technologies, networks and network topologies such as, for example and without limitation, 5G New Radio (NR), 6G, IoT, NB-IoT, Industrial Internet of Things (IIoT) and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a block diagram of an example communication system under a proposed scheme in accordance with the present disclosure.

FIG. 12 is a flowchart of an example process under a proposed scheme in accordance with the present disclosure.

FIG. 13 is a flowchart of an example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvements to UE location delivery in mobile communications. According to the present disclosure, a number of possible solutions may be implemented separately or jointly. That is, although these possible solutions may be described below separately, two or more of these possible solutions may be implemented in one combination or another.

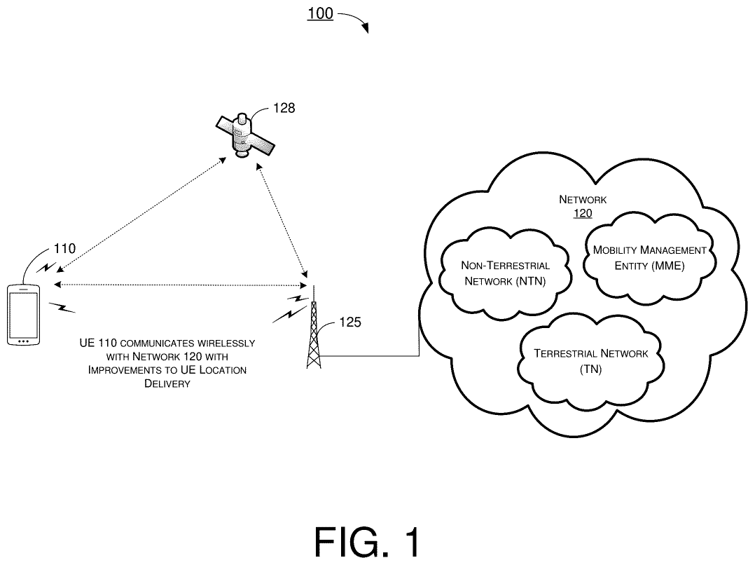

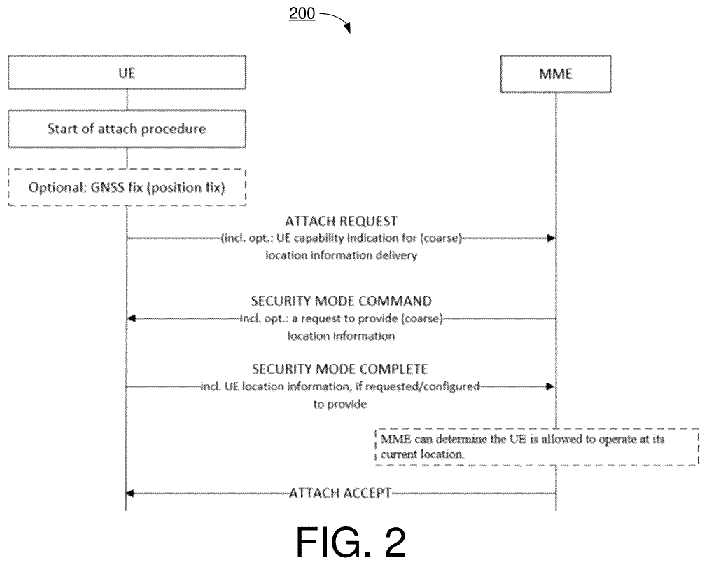

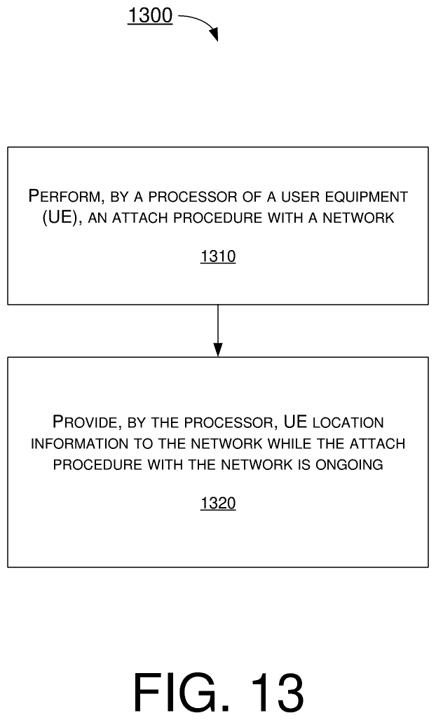

FIG. 1 illustrates an example network environment 100 in which various solutions and schemes in accordance with the present disclosure may be implemented. FIG. 2˜FIG. 13 illustrate examples of implementation of various proposed schemes in network environment 100 in accordance with the present disclosure. The following description of various proposed schemes is provided with reference to FIG. 1˜FIG. 13.

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network) as part of a communication network. UE 110 may initially be in wireless communication with wireless network 120 via a base station or terrestrial network node 125 (e.g., an eNB, gNB or transmit-receive point (TRP)) and/or a satellite or non-terrestrial network node 128. In network environment 100, UE 110 and network 120 may implement various schemes pertaining to improvements to UE location delivery in mobile communications in accordance with the present disclosure, as described below.

Under a first proposed scheme in accordance with the present disclosure, UE location information may be provided in a SECURITY MODE COMPLETE message with or without NAS (EPS) security context. For instance, under the proposed scheme, UE 110 may indicate that it supports delivery of (coarse) location information in NAS signaling (e.g., in an ATTACH REQUEST message in a UE capability information element (IE) or similar IE). In an event that coarse location information is requested by network 120, such as setting coarseLocationReq to “true” (e.g., in a SECURITY MODE COMMAND message), or in an event that UE 110 is configured (or pre-configured) to provide UE location information, UE 110 may provide network 120 with coarse location information in the SECURITY MODE COMPLETE message, if available.

FIG. 2 illustrates an example scenario 200 under the first proposed scheme. Scenario 200 may pertain to a situation in which UE 110 initiates an attach procedure with an ATTACH REQUEST message, a Mobility Management Entity (MME) of network 120 determines that UE 110 is allowed to operate at its current location, and network 120 sends an ATTACH ACCEPT message to UE 110. As shown in FIG. 2, UE 110 may optionally include UE capability indication for delivery of location information (e.g., coarse location information) in the ATTACH REQUEST message. In response, network 120 may optionally include a request to UE 110 to provide (coarse) location information in a SECURITY MODE COMMAND message. Then, UE 110 may include its UE location information, if requested or (pre-)configured to provide such information, in a SECURITY MODE COMPLETE message.

Moreover, using Global Navigation Satellite System (GNSS) fix as a position fix of UE 110 may be optional. The GNSS fix may be a result of GNSS positioning results in a fix, indicating the location of a receiver of UE 110 with a given accuracy. In a satellite E-RTRAN access, a GNSS fix time in lower layers may delay transmission of an initial UL NAS message by up to 100 seconds (GNSS cold state).

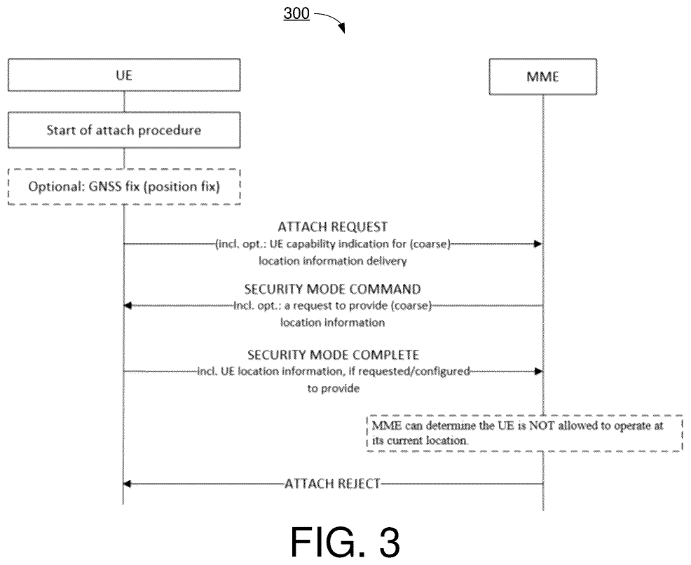

FIG. 3 illustrates an example scenario 300 under the first proposed scheme. Scenario 300 may pertain to a situation in which UE 110 initiates an attach procedure with an ATTACH REQUEST message, an MME of network 120 determines that UE 110 is not allowed to operate at its current location, and network 120 sends an ATTACH REJECT message to UE 110. As shown in FIG. 3, UE 110 may optionally include UE capability indication for delivery of location information (e.g., coarse location information) in the ATTACH REQUEST message. In response, network 120 may optionally include a request to UE 110 to provide (coarse) location information in a SECURITY MODE COMMAND message. Then, UE 110 may include its UE location information, if requested or (pre-)configured to provide such information, in a SECURITY MODE COMPLETE message.

Under a second proposed scheme in accordance with the present disclosure, UE location information may be provided in an ATTACH COMPLETE message with or without NAS (EPS) security context. For instance, under the proposed scheme, UE 110 may indicate that it supports delivery of (coarse) location information in NAS signaling (e.g., in an ATTACH REQUEST message in a UE capability IE or similar IE). In an event that coarse location information is requested by network 120, such as setting coarseLocationReq to “true” (e.g., in an ATTACH ACCEPT message), or in an event that UE 110 is configured (or pre-configured) to provide UE location information, UE 110 may provide network 120 with coarse location information in the ATTACH COMPLETE message, if available.

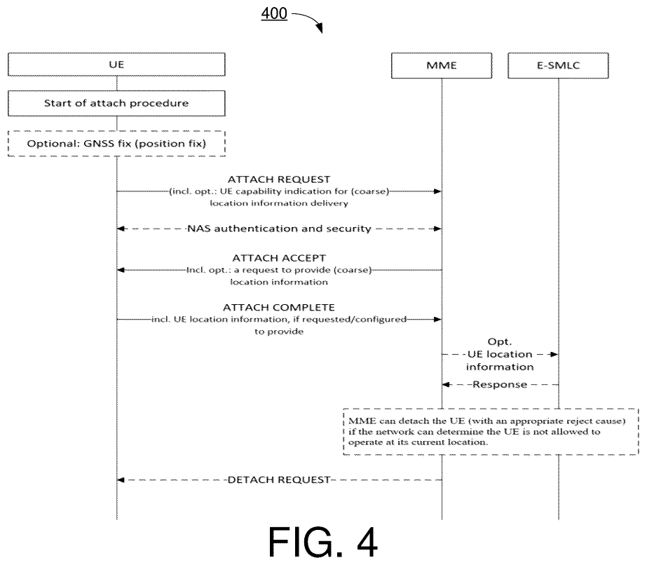

FIG. 4 illustrates an example scenario 400 under the second proposed scheme. Scenario 400 may pertain to a situation in which UE 110 initiates an attach procedure with an ATTACH REQUEST message, an MME of network 120 determines that UE 110 is allowed to operate at its current location, and network 120 sends an ATTACH ACCEPT message to UE 110. As shown in FIG. 4, UE 110 may optionally include UE capability indication for delivery of location information (e.g., coarse location information) in the ATTACH REQUEST message. In response, network 120 may optionally include a request to UE 110 to provide (coarse) location information in the ATTACH ACCEPT message. Then, UE 110 may include its UE location information, if requested or (pre-)configured to provide such information, in an ATTACH COMPLETE message.

Moreover, using GNSS fix as a position fix of UE 110 may be optional. The GNSS fix may be a result of GNSS positioning results in a fix, indicating the location of a receiver of UE 110 with a given accuracy. In a satellite E-RTRAN access, a GNSS fix time in lower layers may delay transmission of an initial UL NAS message by up to 100 seconds (GNSS cold state).

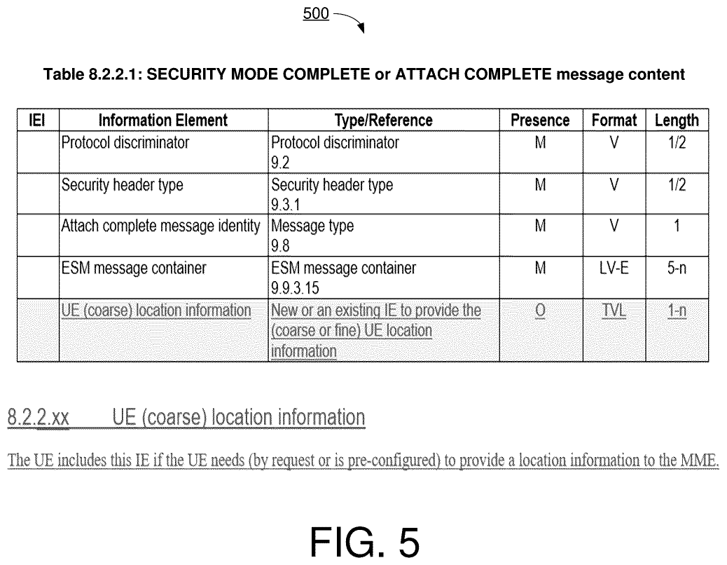

FIG. 5 illustrates an example scenario 500 under the first and second proposed schemes. Scenario 500 may pertain to carrying the UE location information in an ATTACH COMPLETE message under the first and second proposed schemes. For instance, the ATTACH COMPLETE message may include a new IE (not yet defined in current 3GPP specifications at the time of the present invention) or a modified existing IE to provision UE location information to a network.

Under a third proposed scheme in accordance with the present disclosure, UE location information may be provided in an ATTACH REQUEST message with valid NAS (EPS) security context. For instance, under the proposed scheme, UE 110 may send an ATTACH REQUEST message partially ciphered, in case that it includes an EPS Session Management (ESM) message container IE, General message container IE or a NAS message container IE (containing UE location information). UE 110 may partially cipher the ATTACH REQUEST message by ciphering the value part of the ESM message container IE of the General message container or the value part of the NAS message container, using the ciphering algorithm of the current EPS security context.

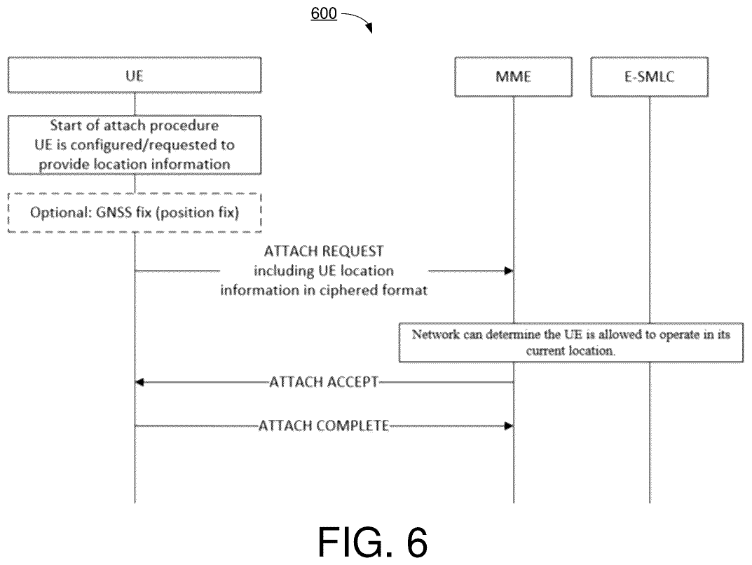

FIG. 6 illustrates an example scenario 600 under the third proposed scheme. Scenario 600 may pertain to a situation in which UE 110 initiates an attach procedure with an ATTACH REQUEST message, network 120 determines that UE 110 is allowed to operate at its current location, and network 120 sends an ATTACH ACCEPT message to UE 110. As shown in FIG. 6, UE 110 may include its UE location information in a ciphered format in the ATTACH REQUEST message.

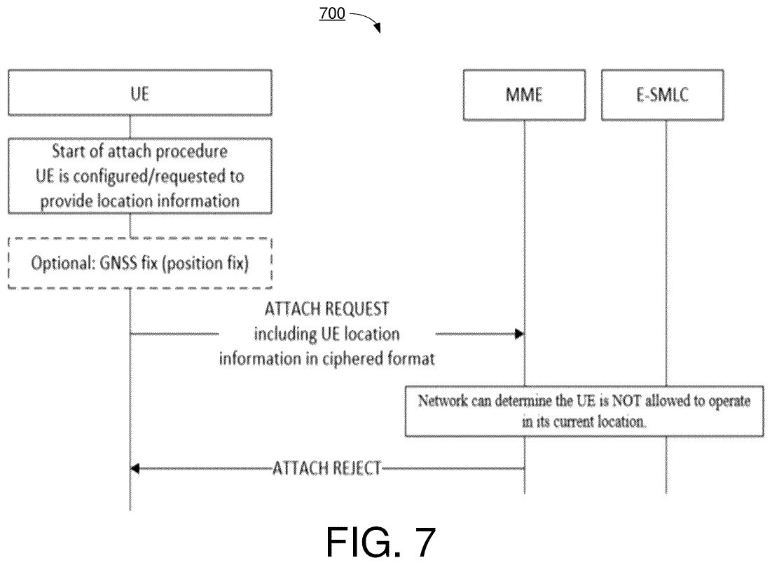

FIG. 7 illustrates an example scenario 700 under the third proposed scheme. Scenario 700 may pertain to a situation in which UE 110 initiates an attach procedure with an ATTACH REQUEST message, network 120 determines that UE 110 is not allowed to operate at its current location, and network 120 sends an ATTACH REJECT message to UE 110. As shown in FIG. 7, UE 110 may include its UE location information in a ciphered format in the ATTACH REQUEST message.

Under a fourth proposed scheme in accordance with the present disclosure, UE location information may be provided in a TAU REQUEST message with valid NAS (EPS) security context. For instance, under the proposed scheme, UE 110 may send a TAU REQUEST message partially ciphered, in case that it includes an EPS Session Management (ESM) message container IE, General message container IE or a NAS message container IE (containing UE location information). UE 110 may partially cipher the ATTACH REQUEST message by ciphering the value part of the ESM message container IE of the General message container or the value part of the NAS message container, using the ciphering algorithm of the current EPS security context.

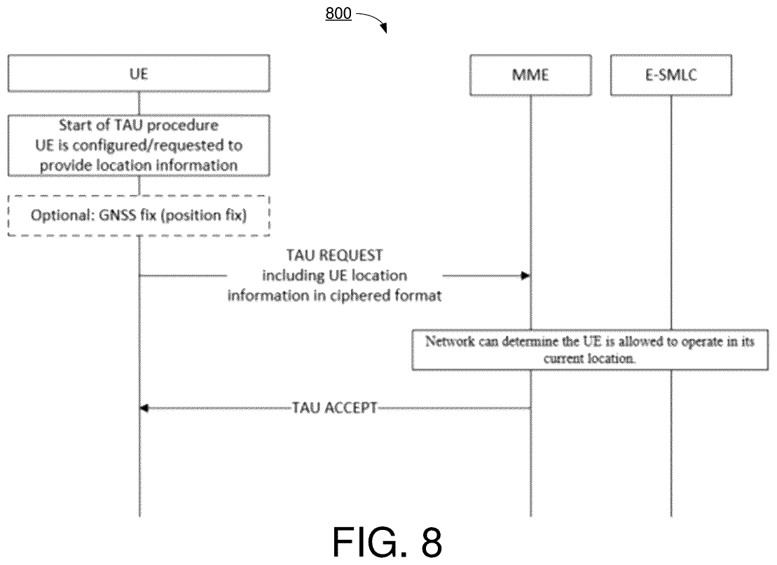

FIG. 8 illustrates an example scenario 800 under the fourth proposed scheme. Scenario 800 may pertain to a situation in which UE 110 initiates an attach procedure with a TAU REQUEST message, network 120 determines that UE 110 is allowed to operate at its current location, and network 120 sends a TAU ACCEPT message to UE 110. As shown in FIG. 8, UE 110 may include its UE location information in a ciphered format in the TAU REQUEST message.

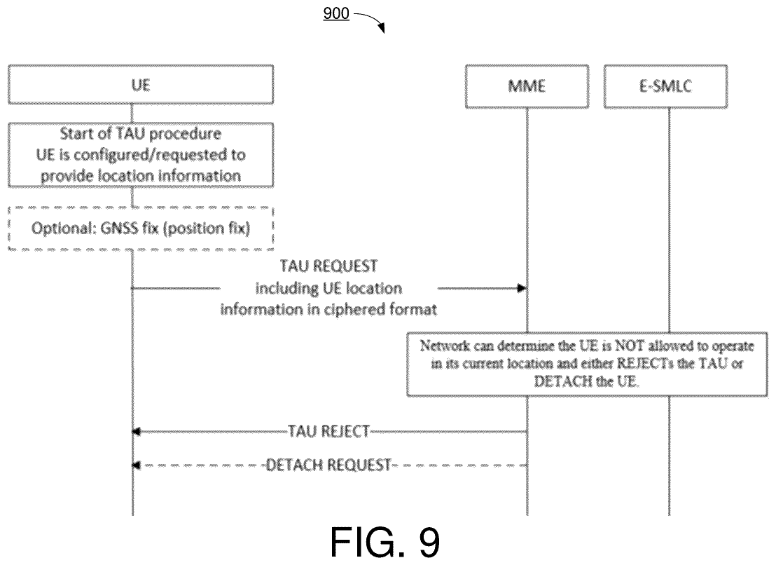

FIG. 9 illustrates an example scenario 900 under the fourth proposed scheme. Scenario 900 may pertain to a situation in which UE 110 initiates an attach procedure with a TAU REQUEST message, network 120 determines that UE 110 is not allowed to operate at its current location so that network 120 either rejects the TAU request or detach UE 110, and network 120 sends either a TAU REJECT message or a DETACH REQUEST message to UE 110. As shown in FIG. 9, UE 110 may include its UE location information in a ciphered format in the TAU REQUEST message.

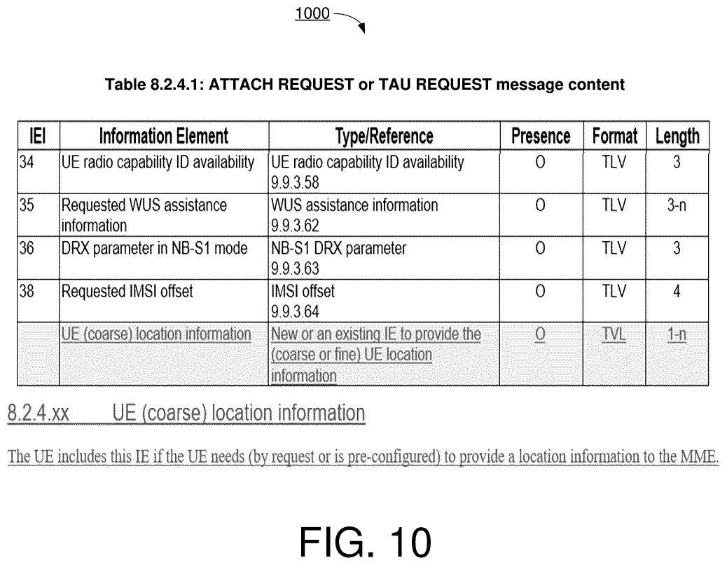

FIG. 10 illustrates an example scenario 1000 under the third and fourth proposed schemes. Scenario 1000 may pertain to carrying the UE location information in an ATTACH REQUEST message under the third proposed scheme or a TAU REQUEST message under the fourth proposed scheme. For instance, the ATTACH REQUEST message or TAU REQUEST message may include a new IE (not yet defined in current 3GPP specifications at the time of the present invention) or a modified existing IE to provision UE location information to a network.

In view of the above, it may be appreciated by those skilled in the art that implementations of one or more schemes proposed herein may allow a UE to provide its location information in an early phase of signaling in a secure manner, such as in an attach procedure, registration procedure, TAU, security mode control or a corresponding 6G procedure while establishing a new NAS signaling connection. One or more of multiple approaches may be taken by a network to request the UE to provide its location information and to encapsulate the UE location information into an UL NAS message (e.g., an ATTACH REQUEST, ATTACH COMPLETE, TAU or SECURITY MODE COMPLETE message).

### Illustrative Implementations

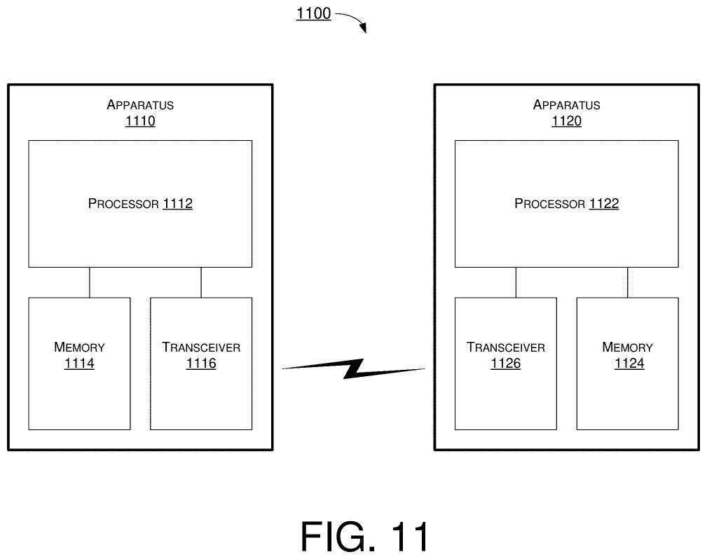

FIG. 11 illustrates an example communication system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to improvements to UE location delivery in mobile communications, including the various schemes described above with respect to various proposed designs, concepts, schemes, systems and methods described above, including network environment 100, as well as processes described below.

Each of apparatus 1110 and apparatus 1120 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1110 and apparatus 1120 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in an eNodeB in an LTE, LTE-Advanced or LTE-Advanced Pro network or in a gNB or TRP in a 5G network, an NR network or an IoT network.

In some implementations, each of apparatus 1110 and apparatus 1120 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1110 and apparatus 1120 may be implemented in or as a network apparatus or a UE. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC or RISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to improvements to UE location delivery in mobile communications in accordance with various implementations of the present disclosure.

In some implementations, apparatus 1110 may also include a transceiver 1116 coupled to processor 1112. Transceiver 1116 may be capable of wirelessly transmitting and receiving data. In some implementations, transceiver 1116 may be capable of wirelessly communicating with different types of wireless networks of different radio access technologies (RATs). In some implementations, transceiver 1116 may be equipped with a plurality of antenna ports (not shown) such as, for example, four antenna ports. That is, transceiver 1116 may be equipped with multiple transmit antennas and multiple receive antennas for multiple-input multiple-output (MIMO) wireless communications. In some implementations, apparatus 1120 may also include a transceiver 1126 coupled to processor 1122. Transceiver 1126 may include a transceiver capable of wirelessly transmitting and receiving data. In some implementations, transceiver 1126 may be capable of wirelessly communicating with different types of UEs/wireless networks of different RATs. In some implementations, transceiver 1126 may be equipped with a plurality of antenna ports (not shown) such as, for example, four antenna ports. That is, transceiver 1126 may be equipped with multiple transmit antennas and multiple receive antennas for MIMO wireless communications.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, as a UE (e.g., UE 110), and apparatus 1120, as a network node (e.g., terrestrial network node 125 or non-terrestrial network node 128) of a wireless network (e.g., network 120), is provided below in the context of example processes 1200 and 1300.

### Illustrative Processes

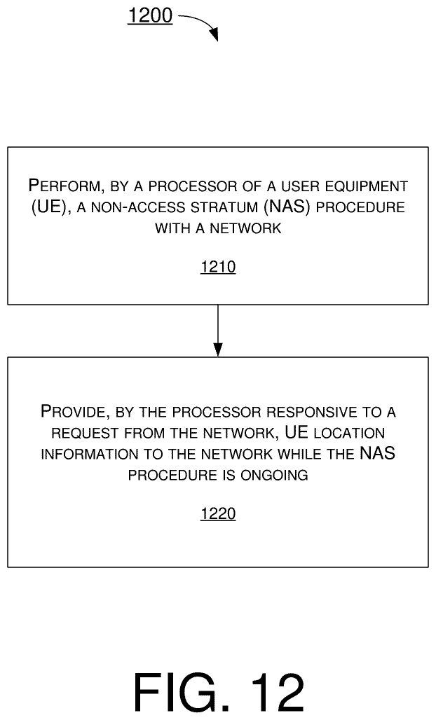

FIG. 12 illustrates an example process 1200 in accordance with an implementation of the present disclosure. Process 1200 may represent an aspect of implementing various proposed designs, concepts, schemes, systems and methods described above, whether partially or entirely, including those pertaining to those described above. More specifically, process 1200 may represent an aspect of the proposed concepts and schemes pertaining to improvements to UE location delivery in mobile communications. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively, in a different order. Furthermore, one or more of the blocks/sub-blocks of process 1200 may be executed iteratively. Process 1200 may be implemented by or in apparatus 1110 and apparatus 1120 as well as any variations thereof. Solely for illustrative purposes and without limiting the scope, process 1200 is described below in the context of apparatus 1110 as a UE (e.g., UE 110) and apparatus 1120 as a communication entity such as a network node or base station (e.g., terrestrial network node 125 or non-terrestrial network node 128) of a wireless network (e.g., wireless network 120). Process 1200 may begin at block 1210.

At 1210, process 1200 may involve processor 1112 of apparatus 1110 performing, via transceiver 1116, a NAS procedure with a network (e.g., wireless network 120 via apparatus 1120 as terrestrial network node 125 or non-terrestrial network node 128). Process 1200 may proceed from 1210 to 1220.

At 1220, process 1200 may involve processor 1112 providing, via transceiver 1116 and responsive to a request from the network, UE location information to the network while the NAS procedure is ongoing.

In some implementations, in performing the NAS procedure, process 1200 may involve processor 1112 performing an attach procedure, a registration procedure, a TAU procedure or a security mode control procedure.

In some implementations, in providing the UE location information, process 1200 may involve processor 1112 including UE coarse location information into a UL NAS message. In some implementations, the UL NAS message may include an ATTACH REQUEST message, an ATTACH COMPLETE message, a TAU REQUEST message or a SECURITY MODE COMPLETE message.

In some implementations, in providing the UE location information, process 1200 may involve processor 1112 performing certain operations. For instance, process 1200 may involve processor 1112 providing, in a first NAS message transmitted by the UE to the network, an indication of UE capability of delivery of the UE coarse location information via NAS signaling. Additionally, process 1200 may involve processor 1112 providing, in a second NAS message transmitted by the UE to the network, the UE coarse location information. In some implementations, the first NAS message may include an ATTACH REQUEST message, and the second NAS message may include a SECURITY MODE COMPLETE message in response to receiving from the network a SECURITY MODE COMMAND message requesting for the UE to provide the UE coarse location information. Alternatively, the first message may include an ATTACH REQUEST message, and the second message may include an ATTACH COMPLETE message in response to receiving from the network an ATTACH ACCEPT message requesting for the UE to provide the UE coarse location information.

In some implementations, in providing the UE location information, process 1200 may involve processor 1112 providing the UE location information in an initial message transmitted by the UE to the network as part of the procedure. In some implementations, in providing the UE location information in the initial message, process 1200 may involve processor 1112 providing the UE location information in an ATTACH REQUEST message or a TAU REQUEST message transmitted by the UE to the network.

In some implementations, in providing the UE location information, process 1200 may involve processor 1112 providing the UE location information in a new IE instead of an existing (or modified existing) IE specific for use to transmit UE coarse location information to the network.

FIG. 13 illustrates an example process 1300 in accordance with an implementation of the present disclosure. Process 1300 may represent an aspect of implementing various proposed designs, concepts, schemes, systems and methods described above, whether partially or entirely, including those pertaining to those described above. More specifically, process 1300 may represent an aspect of the proposed concepts and schemes pertaining to improvements to UE location delivery in mobile communications. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks/sub-blocks of process 1300 may be executed in the order shown in FIG. 13 or, alternatively, in a different order. Furthermore, one or more of the blocks/sub-blocks of process 1300 may be executed iteratively. Process 1300 may be implemented by or in apparatus 1110 and apparatus 1120 as well as any variations thereof. Solely for illustrative purposes and without limiting the scope, process 1300 is described below in the context of apparatus 1110 as a UE (e.g., UE 110) and apparatus 1120 as a communication entity such as a network node or base station (e.g., terrestrial network node 125 or non-terrestrial network node 128) of a wireless network (e.g., wireless network 120). Process 1300 may begin at block 1310.

At 1310, process 1300 may involve processor 1112 of apparatus 1110 performing, via transceiver 1116, an attach procedure with a network (e.g., wireless network 120 via apparatus 1120 as terrestrial network node 125 or non-terrestrial network node 128). Process 1300 may proceed from 1310 to 1320.

At 1320, process 1300 may involve processor 1112 providing, via transceiver 1116, UE location information to the network while the attach procedure with the network is ongoing.

In some implementations, in providing the UE location information, process 1300 may involve processor 1112 performing certain operations. For instance, process 1300 may involve processor 1112 transmitting an ATTACH REQUEST message to the network with an indication of UE capability of delivery of UE coarse location information via NAS signaling. Moreover, process 1300 may involve processor 1112 receiving a SECURITY MODE COMMAND message from the network with a request for the UE to provide the UE coarse location information. Furthermore, process 1300 may involve processor 1112 transmitting a SECURITY MODE COMPLETE message to the network with the UE coarse location information in response to receiving the SECURITY MODE COMMAND message. Additionally, process 1300 may involve processor 1112 receiving an ATTACH ACCEPT message from the network in response to an MME of the network determining that the UE is allowed to operate at its current location. Alternatively, process 1300 may involve processor 1112 receiving an ATTACH REJECT message from the network in response to the MME of the network determining that the UE is not allowed to operate at its current location.

In some implementations, in providing the UE location information, process 1300 may involve processor 1112 performing other operations. For instance, process 1300 may involve processor 1112 transmitting an ATTACH REQUEST message to the network with an indication of UE capability of delivery of UE coarse location information via NAS signaling. Moreover, process 1300 may involve processor 1112 receiving an ATTACH ACCEPT message from the network with a request for the UE to provide the UE coarse location information. Furthermore, process 1300 may involve processor 1112 transmitting an ATTACH COMPLETE message to the network with the UE coarse location information in response to receiving the ATTACH ACCEPT message.

In some implementations, in providing the UE location information, process 1300 may involve processor 1112 providing the UE location information in a new IE instead of an existing (or modified existing) IE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a user equipment (UE), a non-access stratum (NAS) procedure with a network; and
providing, by the processor responsive to a request from the network, UE location information to the network while the NAS procedure is ongoing.

2. The method of claim 1, wherein the NAS procedure comprises an attach procedure, a registration procedure, a tracking area update (TAU) procedure or a security mode control procedure.

3. The method of claim 1, wherein the providing of the UE location information comprises including UE coarse location information into an uplink (UL) NAS message.

4. The method of claim 3, wherein the UL NAS message comprises an ATTACH REQUEST message, an ATTACH COMPLETE message, a TAU REQUEST message or a SECURITY MODE COMPLETE message.

5. The method of claim 1, wherein the providing of the UE location information comprises:
providing, in a first NAS message transmitted by the UE to the network, an indication of UE capability of delivery of UE coarse location information via NAS signaling; and
providing, in a second NAS message transmitted by the UE to the network, the UE coarse location information.

6. The method of claim 5, wherein the first NAS message comprises an ATTACH REQUEST message, and wherein the second NAS message comprises a SECURITY MODE COMPLETE message in response to receiving from the network a SECURITY MODE COMMAND message requesting for the UE to provide the UE coarse location information.

7. The method of claim 5, wherein the first message comprises an ATTACH REQUEST message, and wherein the second message comprises an ATTACH COMPLETE message in response to receiving from the network an ATTACH ACCEPT message requesting for the UE to provide the UE coarse location information.

8. The method of claim 1, wherein the providing of the UE location information comprises providing the UE location information in an initial message transmitted by the UE to the network as part of the procedure.

9. The method of claim 8, wherein the providing of the UE location information in the initial message comprises providing the UE location information in an ATTACH REQUEST message or a tracking area update (TAU) REQUEST message transmitted by the UE to the network.

10. The method of claim 1, wherein the providing of the UE location information comprises providing the UE location information in a new information element (IE) specific to transmit UE coarse location information to the network.

11. A method, comprising:
performing, by a processor of a user equipment (UE), an attach procedure with a network; and
providing, by the processor, UE location information to the network while the attach procedure with the network is ongoing.

12. The method of claim 11, wherein the providing of the UE location information comprises:
transmitting an ATTACH REQUEST message to the network with an indication of UE capability of delivery of UE coarse location information via NAS signaling;
receiving a SECURITY MODE COMMAND message from the network with a request for the UE to provide the UE coarse location information; and
transmitting a SECURITY MODE COMPLETE message to the network with the UE coarse location information in response to receiving the SECURITY MODE COMMAND message.

13. The method of claim 12, further comprising:
receiving an ATTACH ACCEPT message from the network in response to a Mobility Management Entity (MME) of the network determining that the UE is allowed to operate at its current location.

14. The method of claim 12, further comprising:
receiving an ATTACH REJECT message from the network in response to a Mobility Management Entity (MME) of the network determining that the UE is not allowed to operate at its current location.

15. The method of claim 11, wherein the providing of the UE location information comprises:
transmitting an ATTACH REQUEST message to the network with an indication of UE capability of delivery of UE coarse location information via NAS signaling;
receiving an ATTACH ACCEPT message from the network with a request for the UE to provide the UE coarse location information; and
transmitting an ATTACH COMPLETE message to the network with the UE coarse location information in response to receiving the ATTACH ACCEPT message.

16. An apparatus implementable in a user equipment (UE), comprising:
a transceiver configured to communicate wirelessly; and
a processor coupled to the transceiver and configured to perform operations comprising:
performing, via the transceiver, an attach procedure with a network; and
providing, via the transceiver, UE location information to the network while the attach procedure with the network is ongoing.

17. The apparatus of claim 16, wherein the providing of the UE location information comprises:
transmitting an ATTACH REQUEST message to the network with an indication of UE capability of delivery of UE coarse location information via NAS signaling;
receiving a SECURITY MODE COMMAND message from the network with a request for the UE to provide the UE coarse location information; and
transmitting a SECURITY MODE COMPLETE message to the network with the UE coarse location information in response to receiving the SECURITY MODE COMMAND message.

18. The apparatus of claim 17, wherein the processor is further configured to perform operations comprising:
receiving an ATTACH ACCEPT message from the network in response to a Mobility Management Entity (MME) of the network determining that the UE is allowed to operate at its current location.

19. The apparatus of claim 17, wherein the processor is further configured to perform operations comprising:
receiving an ATTACH REJECT message from the network in response to a Mobility Management Entity (MME) of the network determining that the UE is not allowed to operate at its current location.

20. The apparatus of claim 16, wherein the providing of the UE location information comprises:
transmitting an ATTACH REQUEST message to the network with an indication of UE capability of delivery of UE coarse location information via NAS signaling;
receiving an ATTACH ACCEPT message from the network with a request for the UE to provide the UE coarse location information; and
transmitting an ATTACH COMPLETE message to the network with the UE coarse location information in response to receiving the ATTACH ACCEPT message.
